(19) United States
(12) Patent Application Publication
(10) Pub. No.: US 2024/0005096 A1
(43) Pub. Date: Jan. 4, 2024

(54) ATTRIBUTE PREDICTION WITH MASKED LANGUAGE MODEL

(71) Applicant: Maplebear Inc. (dba Instacart), San Francisco, CA (US)

(72) Inventors: Ramasubramanian Balasubramanian, San Francisco, CA (US); Saurav Manchanda, Minneapolis, MN (US)

(21) Appl. No.: 17/855,799

(22) Filed: Jul. 1, 2022

(51) Int. Cl. G06F 40/284; G06F 40/186; G06N 5/02

(52) U.S. Cl. CPC G06F 40/284; G06F 40/186; G06N 5/022

(57) ABSTRACT

A masked language model is used to predict an attribute of an object, such as a physical item or product based on the predicted value of a masked token. The masked language model may be trained on a general corpus of text for the language, such that the masked language model learns context and text token relationships. Information about the object may then be added to a query template that structures the item information in an attribute query that may be interpretable by the masked language model to provide a resulting token related to the provided information or to confirm or reject an attribute specified in the query template.

### BACKGROUND

This disclosure relates generally to computer software for attribute prediction, and more specifically to predicting object attributes with a masked language model.

Accurate description of object attributes is important for many purposes. Particularly difficult challenges arise in automated computer prediction (e.g., via trained computer-based, machine-learning models) of attributes based on dynamic, freeform, unstructured, or unpredictable text, especially when limited (or no) training data is available. As an example, information about a physical product (e.g., grocery items) may include some specified attributes, such as a name or an item type within a hierarchy, but may lack additional ingredient or dietary information (e.g., whether the product is non-fat or gluten free). These attributes (which may also be referred to as properties) may be difficult for typical models to effectively learn to predict because the information about individual products may vary, may include freeform text (e.g., a product description or review as freeform text), and may have limited examples available for use with known labels (e.g., attribute values) in training computer models.

### SUMMARY

In accordance with one or more aspects of the disclosure, to improve attribute prediction for objects, a masked language model is used to predict the attribute by constructing an attribute query for the model using a prompt template and object data for the object. As one example, the object may be a product, and the object data may be a text description of the product. The masked language model is configured to predict the likelihood of a token (e.g., a word) in a text string as a “fill-in-the-blank” problem. Masked language models may use contextual information from the text string to evaluate whether a token may properly “belong” in the masked portion of the text string. The masked language model may be trained on a large corpus of documents or other data, such as examples that may be extracted from typical use of the language, e.g., through web page crawling, news sources, books, encyclopedia entries, etc. In some circumstances, the training data may also include additional examples describing information associated with the objects (e.g., products) to be characterized by the model.

To use the language model for attribute prediction, information about the object is identified and added to a prompt template to form an input that may provide terms and context to the language model for predicting the attribute. The model may then predict the attribute as a masked token in the query, or the attribute may be a portion of the attribute query, such that the language model predicts the relative likelihood of a positive or negative response, such as “yes” or “no,” which may indicate the likelihood of the attribute. Since the language model may be generated based on general information about the language (e.g., training data that is not specific to the application to the attribute query), the language model may be used with the constructed attribute query to extract relevant information about the attribute from the object data based on the general language information reflected in the language model. Moreover, the language model is trained with knowledge embedded from the corpus of documents, not just labeled data that is specific to the application to the attribute query. Therefore, the language model could learn that something labeled “wheat” is not “gluten-free” based on the knowledge embedded in the general corpus of documents used to train it, whereas a traditional classification model would require specific structured labels that relate “wheat” to being not “gluten-free.”

The language model may be further trained (e.g., fine-tuned) based on training examples of the query attribute and labeled attributes, which in some embodiments may further improve the effectiveness of the predicted attributes with the language model. As the language model may already represent significant context and token relationships effectively, relatively few examples may be used to further train the language model for attribute predictions.

The predicted attribute for the object may then be used for further processing of the object that may vary in different contexts and embodiments. In one example, the objects may be products or other content items that may be searched or queried with an object query. The objects relevant to the query may be affected by the predicted attribute, such that objects with the attribute may be ranked higher or lower as being responsive to the object query. As such, in some embodiments, products having unstructured text descriptions may be processed by the language model to identify further attributes otherwise unspecified by the text or other product information and thereby facilitate improved product retrieval for queries.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a flowchart for predicting object attributes with a masked language model, according to one or more embodiments.

FIG. 6 is a flowchart for determining an attribute prediction with a masked language model, according to one or more embodiments.

FIG. 7 is a flowchart for determining one or more prompt templates for use in attribute prediction by a masked language model, according to one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Architecture

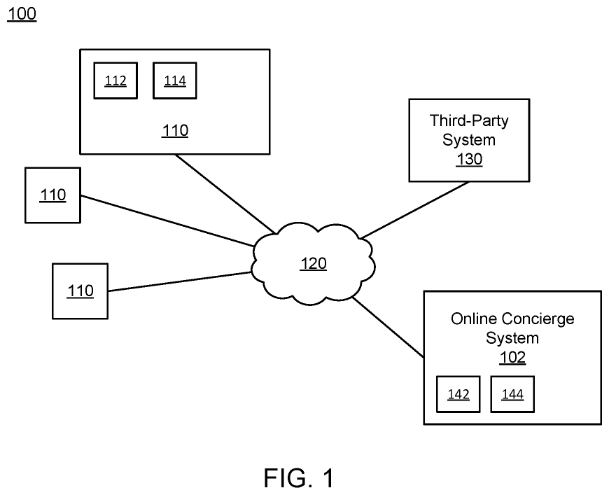

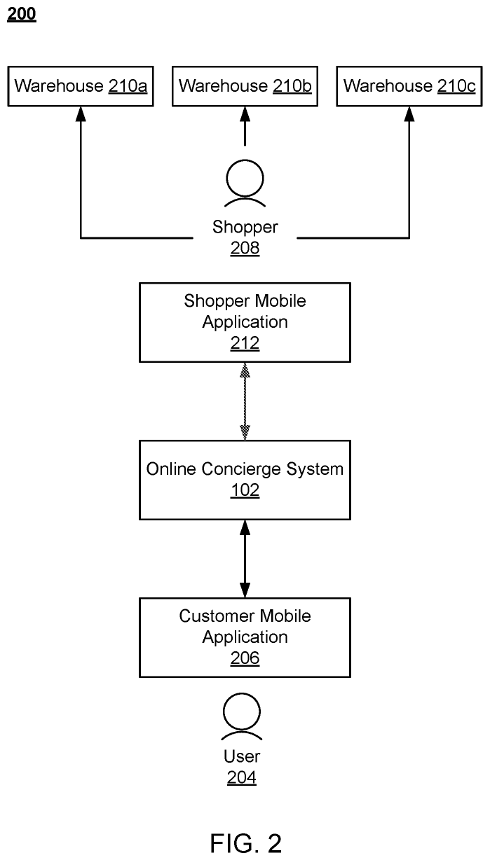

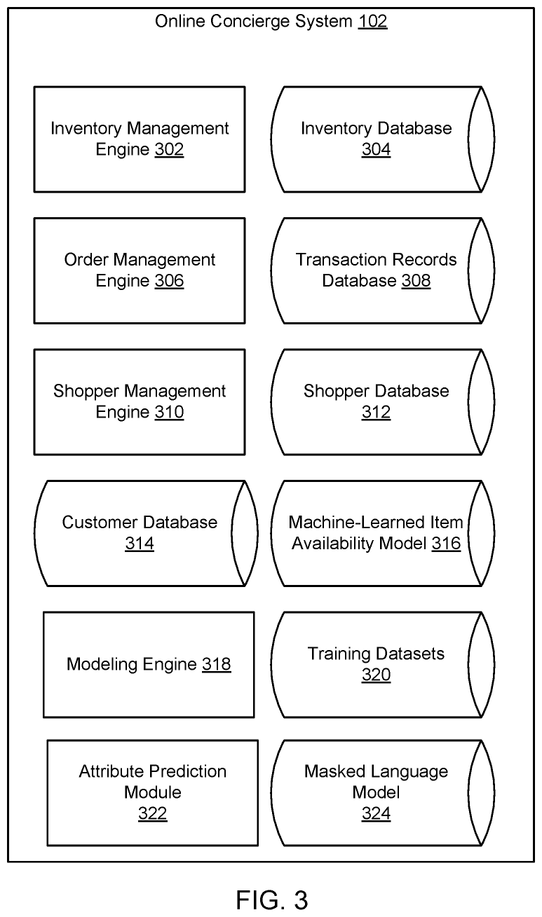

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

The online concierge system 102 is one example of a system that may use the attribute prediction for objects as discussed herein. Attributes may be predicted for objects for which there is unstructured data that typically does not expressly describe whether the object has the attribute (or a value thereof). Rather, the object is associated with object data that includes unstructured data as a text string (or that may be converted to a text string) that describes the object. In the examples discussed below, the objects are typically products listed in conjunction with the online concierge system 102, and the object data includes a textual description of the product as further discussed below. The principles discussed herein are applicable to additional types of objects and by different types of systems in various embodiments.

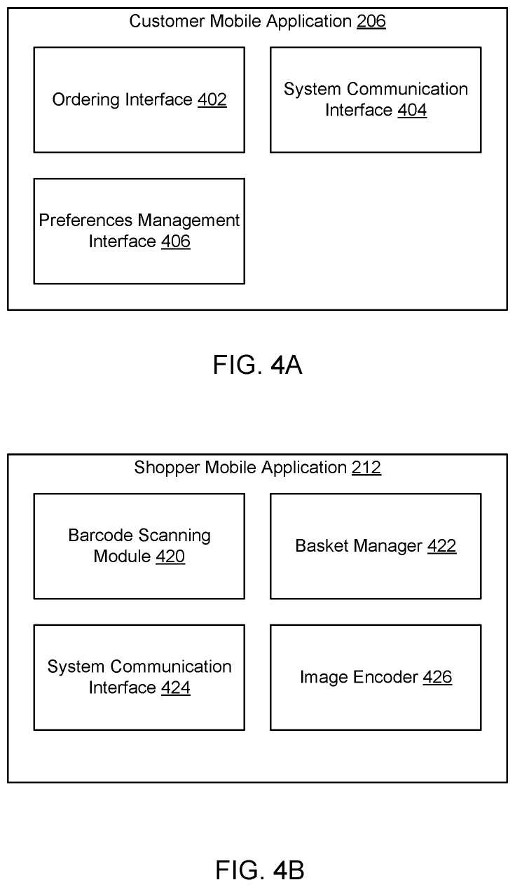

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online concierge system 102 or with the one or more client devices 110. In one embodiment, a third-party system 130 is an application provider communicating information describing applications for execution by a client device 110 or communicating data to client devices 110 for use by an application executing on the client device. In other embodiments, a third-party system 130 provides content or other information for presentation via a client device 110. For example, the third-party system 130 stores one or more web pages and transmits the web pages to a client device 110 or to the online concierge system 102. The third-party system 130 may also communicate information to the online concierge system 102, such as advertisements, content, or information about an application provided by the third-party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below that, when executed by the processor 142, cause the processor to perform the described functionality. For example, the memory 144 has instructions encoded thereon that, when executed by the processor 142, cause the processor 142 to predict attributes with a masked language model based on an attribute query. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device 110, a third-party system 130, or the online concierge system 102 may be special-purpose computing devices configured to perform specific functions as further described below, and may include specific computing components such as processors, memories, communication interfaces, and the like.

### System Overview

FIG. 2 illustrates an environment 200 of an online platform, such as an online concierge system 102, according to one or more embodiments. The figures use like-reference numerals to identify like-elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users 204. Each shopper 208 fulfills an order received from the online concierge system 102 at one or more warehouses 210, delivers the order to the user 204, or performs both fulfillment and delivery. In one embodiment, shoppers 208 make use of a shopper mobile application 212, which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and quantitative information about the items, including size, color, weight, stock keeping unit (SKU), serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not-found (a shopper looked for the item but could not find it), the rate at which the item is found, and the popularity of the item.

For each item, the inventory database 304 identifies one or more attributes of the item and any corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items. In various embodiments, the attributes may be provided by or based on information specified by a warehouse, item catalog, or other external source.

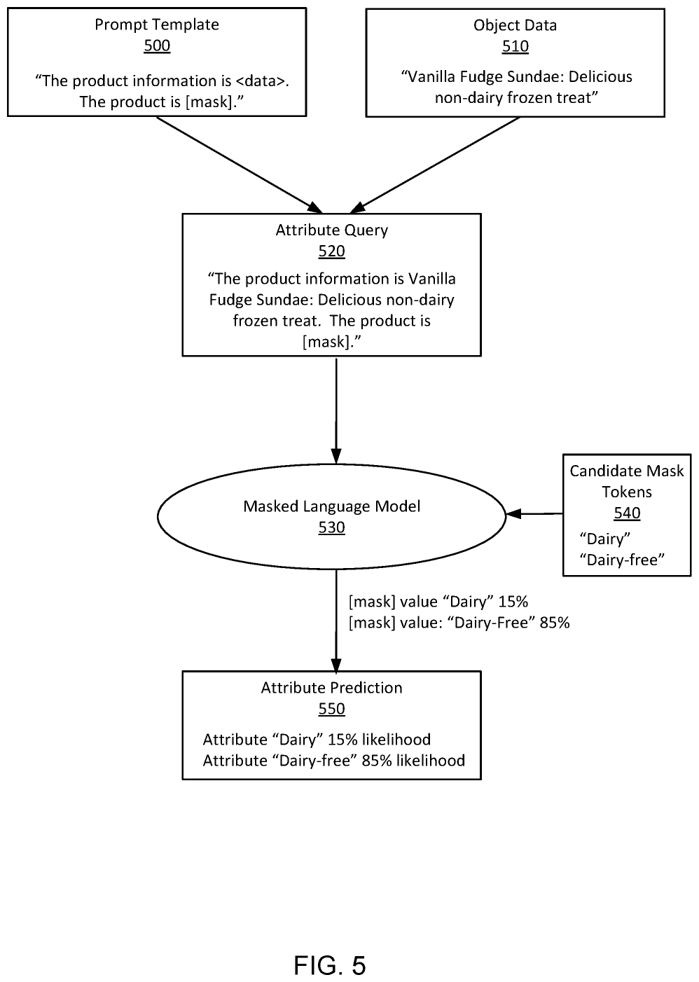

In additional embodiments, attributes (or attribute values) for items (e.g., a product), may be predicted or inferred by an attribute prediction module 322 of the online concierge system 102 based on information about the item. This may be used to supplement or add information to the items. For example, a grocery item may have a name “Almond Milk” and a textual description “Pure Almond-derived Milk, no additives and never concentrated” and may otherwise not be provided with additional attributes that may be relevant to the item, such as its type, whether it is nut-free or dairy-free, and so forth. In some embodiments, the attribute prediction module 322 may use a masked language model for predicting attributes based on text associated with the items. These attributes may include, for example, characteristics of the item that may be mutually exclusive classifications, such as its type (e.g., whether the item is a fruit, vegetable, meat, fish, etc.), or its nutritional characteristics (e.g., zero fat, low-fat, or not reduced fat). Attributes may also describe characteristics that may relate to Boolean characteristics, such as whether a product has a specific feature, property, ingredient, etc. For food items, this may include, for example, whether an item is gluten-free, dairy-free, nut-free, and so forth. After a prediction by the attribute prediction module 322, the attributes may be associated with the items in the inventory database 304, and may be designated as being inferred, rather than provided attributes of the item. For example, when a user searches for “dairy-free” items, the online concierge system 102 may indicate to the user which items are dairy-free based on information provided by a supplier or manufacturer, and which items are predicted to be dairy-free (but for which a user may wish to confirm based on the user's inspection of the item). The attribute prediction process and components are further discussed with respect to FIGS. 5-7. Though generally discussed in the context of products or items, the attribute prediction discussed herein may generally be applied to other types of objects for which information is available and may be processed by the discussed approaches.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. Different levels in the taxonomy may provide different levels of specificity about items included in the levels. In various embodiments, the taxonomy identifies a category and associates one or more specific items with a category. For example, a category identifies “milk,” and the taxonomy associates identifiers of different milk items (e.g., milk offered by different brands, milk having one or more different attributes, etc.) with that category. Thus, the taxonomy maintains associations between a category and specific items offered by the warehouse 210 matching the category. In some embodiments, different levels in the taxonomy identifies items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., lower levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

The online concierge system 102 also includes an order management engine 306, which is configured to synthesize and display an ordering interface to each user 204 (for example, via the customer mobile application 206). The order management engine 306 is also configured to access the inventory database 304 to determine which products are available at which specific warehouse 210. The order management engine 306 may supplement the product availability information from the inventory database 304 with an item availability predicted by a machine-learned item availability model 316. The order management engine 306 determines a sale price for each item ordered by a user 204. Prices set by the order management engine 306 may or may not be identical to other prices determined by retailers (such as a price that users 204 and shoppers 208 may pay at the retail warehouses). The order management engine 306 also facilitates any transaction associated with each order. In one embodiment, the order management engine 306 charges a payment instrument associated with a user 204 when he/she places an order. The order management engine 306 may transmit payment information to an external payment gateway or payment processor. The order management engine 306 stores payment and transactional information associated with each order in a transaction records database 308.

In various embodiments, the order management engine 306 generates and transmits a search interface to a client device 110 of a user 204 for display via the customer mobile application 206. The order management engine 306 receives a query comprising one or more terms from a user 204 and retrieves items satisfying the query, such as items having descriptive information matching at least a portion of the query. In various embodiments, the order management engine 306 leverages item embeddings for items to retrieve items based on a received query. For example, the order management engine 306 generates an embedding for a query and determines measures of similarity between the embedding for the query and item embeddings for various items included in the inventory database 304.

In addition, the order management engine 306 may use attributes, including predicted or inferred attributes by the attribute prediction module 322, for scoring, filtering, or otherwise evaluating the relevance of items as responsive to the order query. As such, the attributes predicted (i.e., inferred) by the attribute prediction module 322 may be added to the inventory database 304 and used to improve various further uses and processing of the item information, of which order query is one example. In general, the additional attributes of an object that may be predicted by the attribute prediction module 322 may be used for a variety of purposes according to the particular embodiment, type of object, predicted attributes, etc.

To use attributes for an order query, attributes relevant to the order query may be determined from the order query. The attributes may be explicitly designated or may be inferred from the order or from the user placing the order. For example, an order query may provide a text search for “milk” and specify that results to the query should include only items with the attribute “dairy-free.” In other examples, the user may be associated with dietary restrictions or other attribute preferences and indicate that the online concierge system 102 may automatically apply these preferences to queries or orders from that user.

The attributes associated with the query may specify an attribute is required, preferred, or should be excluded, and the order management engine 306 may filter and rank resulting items based on whether the item is associated with the attributes of the query. For example, the “dairy-free” attribute in the query may permit the order management engine 306 to exclude items which are not explicitly listed as dairy-free or predicted to have that attribute. The order management engine 306 may then score and rank items and provide the items to the user responsive to the query. For items that were predicted to have a desired attribute by the attribute prediction module 322, in some embodiments, the user may be provided with an indication that the attribute was a prediction based on other information about the item so that the user can confirm whether the item satisfies the attribute and may not rely exclusively on the prediction. This may be particularly important, for example, when users provide dietary restrictions such as “nut-free” so that users may confirm the item is appropriate for the user's request.

In some embodiments, the order management engine 306 also shares order details with warehouses 210. For example, after successful fulfillment of an order, the order management engine 306 may transmit a summary of the order to the appropriate warehouses 210. The summary may indicate the items purchased, the total value of the items, and in some cases, an identity of the shopper 208 and user 204 associated with the transaction. In one embodiment, the order management engine 306 pushes the transaction and/or order details asynchronously to associated retailer systems. This may be accomplished via use of webhooks, which enable programmatic or system-driven transmission of information between web applications. In another embodiment, retailer systems may be configured to periodically poll the order management engine 306, which provides details of all orders which have been processed since the last poll request.

The order management engine 306 may interact with a shopper management engine 310, which manages communication with and utilization of shoppers 208. In one embodiment, the shopper management engine 310 receives a new order from the order management engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312, which stores information describing each shopper 208, such as his/her name, gender, rating, previous shopping history, and so on.

As part of fulfilling an order, the order management engine 306 and/or shopper management engine 310 may access a customer database 314 which stores information describing each user (e.g., a customer). This information could include each user's name, address, gender, shopping preferences, favorite items, stored payment instruments, and so on.

In various embodiments, the order management engine 306 determines whether to delay display of a received order to shoppers for fulfillment by a time interval. In response to determining to delay the received order by a time interval, the order management engine 306 evaluates orders received after the received order and during the time interval for inclusion in one or more batches that also include the received order. After the time interval, the order management engine 306 displays the order to one or more shoppers via the shopper mobile application 212; if the order management engine 306 generated one or more batches including the received order and one or more orders received after the received order and during the time interval, the one or more batches are also displayed to one or more shoppers via the shopper mobile application 212.

### Machine Learning Models—Item Availability

The online concierge system 102 further includes a machine-learned item availability model 316, a modeling engine 318, and training datasets 320. The modeling engine 318 uses the training datasets 320 to generate one or more machine-learned models, such as the machine-learned item availability model 316. The machine-learned item availability model 316 can learn from the training datasets 320, rather than follow only explicitly programmed instructions. The inventory management engine 302, order management engine 306, and/or shopper management engine 310 can use the machine-learned item availability model 316 to determine a probability that an item is available at a warehouse 210. The machine-learned item availability model 316 may be used to predict item availability for items being displayed to a user, selected by a user, or included in received delivery orders. The machine-learned item availability model 316 may be used to predict the availability of any number of items.

The machine-learned item availability model 316 can be configured to receive, as inputs, information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers unique to the two warehouses. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the machine-learned item availability model 316.

The machine-learned item availability model 316 contains a set of functions generated by the modeling engine 318 from the training datasets 320 that relate the item, warehouse, timing information, and/or any other relevant inputs, to the probability that a particular item is available at a particular warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be an error or uncertainty score of the output availability probability and may be calculated using any standard statistical error measurement. In some examples, the confidence score is based, in part, on whether the item-warehouse pair availability prediction was accurate for previous delivery orders (e.g., if the item was predicted to be available at the warehouse and was not found by the shopper or predicted to be unavailable but found by the shopper). In some examples, the confidence score is based, in part, on the age of the data for the item, e.g., if availability information has been received within the past hour, or the past day. The set of functions of the machine-learned item availability model 316 may be updated and adapted following retraining with new training datasets 320. The machine-learned item availability model 316 may be any machine-learning model, such as a neural network, boosted tree, gradient boosted tree, or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 includes training data from which the machine-learned models may learn parameters, such as weights, model structure, and other aspects for developing predictions. For the machine-learned item availability model 316, the training datasets 320 may relate a variety of different factors to known item availabilities from the outcomes of previous delivery orders (e.g., if an item was previously found or previously unavailable). The training datasets 320 include the items included in previous delivery orders, whether the items in previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weigh these factors differently, where the weights are a result of a “learning” or training process on the training datasets 320. The training datasets 320 are very large datasets taken across a wide cross-section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previously delivered order. If a particular item has recently been picked at a warehouse, this may increase the probability that it is still available. If there has been a long time interval since a particular item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between the time information and item availability are determined by the modeling engine 318 training a machine-learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Machine Learning Models—Attribute Prediction & Language Models

The training datasets 320 may include additional data for training additional computer models, such as a masked language model 324 and other models as discussed in FIGS. 5-7. The training datasets 320 for the masked language model 324 may include a corpus of language-related text. The models trained for attribute prediction and used by the attribute prediction module 322 may include a masked language model 324 and other types of models, such as a text-text model as further discussed below. The training datasets 320 for the language models may include example text representing typical or normal use of language and may include data collected from website crawlers (e.g., collecting web page information), books, magazines, encyclopedia entries, and/or other sources of language use that may indicate ways in which language and words (e.g., represented as text tokens) are used in practice. This training data may thus include example uses of language that may be used to train the masked language model 324 to learn the use and relationship of individual words and context of words with respect to grammar and other terms within a portion of text, such as a text string. Each word may be represented as a text “token” in the masked language model 324.

The masked language model 324 is trained with the training data that masks a portion of the input text and is trained to predict the masked portion of the input. For example, the training input may be “In autumn, the leaves fall to the ground,” in which the word “leaves” may be masked, such that the model is configured to predict the token that should replace the masked word in: “In autumn, the [MASK] fall to the ground.” While “leaves” was masked in the input (e.g., as training data) and may be the text token used as a positive training output, the model may also predict semantically and/or contextually similar text tokens that may be likely or possible terms, such as “apples” or “petals.” As such, the masked language model 324 learns to accomplish a “fill-in-the-blank” task for replacing the masked term in an input with a text token. BERT (Bidirectional Encoder Representations from Transformers) is one example structure for a masked language model 324. The modeling engine 318 may train the masked language model 324 based on training instances from the corpus of language in the training datasets 320 and may also include object information, such as item descriptive information, from the inventory database 304. The modeling engine 318 may also further train or “fine tune” parameters of the masked language model 324 based on training instances of attribute queries as further discussed below.

### Customer Mobile Application

FIG. 4A is a diagram of the customer mobile application (CMA) 206, according to one or more embodiments. The CMA 206 includes an ordering interface 402, which provides an interactive interface with which the user 204 can browse through and select items/products and place an order. The CMA 206 also includes a system communication interface 404 which, among other functions, receives inventory information from the online shopping concierge system 102 and transmits order information to the online concierge system 102. The CMA 206 also includes a preferences management interface 406 which allows the user 204 to manage basic information associated with his/her account, such as his/her home address and payment instruments. The preferences management interface 406 may also allow the user 204 to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 208 to manually enter information describing an item (such as its serial number, SKU, quantity and/or weight) if a barcode is not available to be scanned. SMA 212 also includes a basket manager 422, which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424, which interacts with the online concierge system 102. For example, the system communication interface 424 receives an order from the online concierge system 102 and transmits the contents of a basket of items to the online concierge system 102. The SMA 212 also includes an image encoder 426, which encodes the contents of a basket into an image. For example, the image encoder 426 may encode a basket of goods (with an identification of each item) into a quick response (QR) code which can then be scanned by an employee of the warehouse 210 at check-out.

### Masked Language Model for Attribute Prediction

FIG. 5 is a flowchart for predicting object attributes with a masked language model, according to one or more embodiments. This flow may be performed by the attribute prediction module 322 in an online concierge system 102 for various items and products to be ordered. For example, online concierge system 102 may execute one or more steps illustrated in the flowchart to predict object attributes with a masked language model. In some arrangements, the principles associated with this flowchart may be applied to many different types of objects, which may include other types of physical objects as well as electronic data, and objects for which attributes may be determined based on textual information. For example, sentiment-related attributes may be determined for objects, such as for books or movies, where the sentiment-related attributes describe an evaluation of a book or movie as an attribute of “great” or “awful,” which may also be determined in a similar way.

To predict an attribute for an object, the attribute prediction module 322 constructs an attribute query 520 for input to the masked language model 530 with a prompt template 500 and object data 510. The attribute query 520 includes a text string having a masked portion (e.g., a masked value) for the masked language model 530 to predict the likelihood of particular mask tokens (e.g., text that may be placed in a position of the masked value). Rather than directly using object data 510 to form a query, the attribute query 520 is generated based on the prompt template 500 to provide additional context and information to the masked language model 530. The prompt template 500 may include a first location in which to insert the relevant object data 510, and a second location designating the masked value to be predicted by the masked language model 530. The prompt template thus provides a “wrapper” providing additional information that may be interpreted by the masked language model 530 in effectively predicting the masked value. Because the masked language model 530 may be trained on general language examples, as discussed above, the masked language model 530 may learn to receive sentences (e.g., unstructured text sentences) and sequential text concepts rather than specifically structured data. As such, the prompt template 500 provides the context and sequencing that improve the masked language model prediction of the masked value based on the attribute query 520.

The object data 510 may be any suitable information about the object that may be provided as a text string for insertion in the prompt template 500. The text string for the object data may also be considered to be unstructured in that it does not specifically designate or characterize aspects of the text string to be used in the attribute query. The object data 510 may thus include, for example, the name of the object, description, currently-known attributes, and so forth. In one embodiment in which the object is a product, the object data may include a product description of the product. The text string used as the object data 510 may be generated by retrieving, combining, and/or processing information about the object. For example, in one embodiment, different types of information about the product may be concatenated to form the object data 510. The object data 510 may also be processed to clean the object data 510 of terms (i.e., words) that may otherwise obfuscate processing by the masked language model 530. For example, the retrieved information may be processed to filter or otherwise remove trademarks, trade names, proprietary product names, proper nouns, and so forth.

To generate the attribute query 520, the object data 510 may be inserted in the designated location of the prompt template 500. In the example of FIG. 5, the prompt template is “The product information is <data>. The product is [mask].” In which “<data>” signifies where the object data 510 is inserted in the template. Accordingly, the object data 510 of “Vanilla Fudge Sundae: Delicious non-dairy frozen treat” is inserted in this example in the prompt template 500 to yield attribute query 520 of “The product information is Vanilla Fudge Sundae: Delicious non-dairy frozen treat. The product is [mask].” This forms a string of text that may then be interpreted by the masked language model 530 for predicting what token may appropriately be the masked value in the attribute query 520.

The attribute may be presented for prediction in different ways in various embodiments. In the embodiment of FIG. 5, a set of candidate mask tokens 540 may be evaluated by the masked language model 530 for consideration as the masked value of the attribute query. While the masked language model 530 may be trained on a large corpus of text including a very large number of text tokens, the tokens to be considered as the masked value in the attribute query 520 may be narrowed to the candidate mask tokens 540 to further structure the application of the masked language model 530 to the prediction of attributes for the object. In this example, the candidate mask tokens 540 may correspond to classifications of attributes for the object. Each of the candidate mask tokens may be evaluated by the masked language model, and the respective likelihood 550 of each may be predicted. In one embodiment, a softmax function may be applied to the predictions for the candidate mask tokens to normalize (e.g., to total 100%) the predicted likelihood 550 across the set of candidate mask tokens. In this example, the normalized predictions for the mask values are 15% for the candidate mask token “Dairy” and 85% for the candidate mask token “Dairy-Free.” In this example, the respective predictions may be assigned to the likelihood 550 of the respective attributes “Dairy” and “Dairy-free.”

While in this example two candidate mask tokens 540 are shown, in other examples, the candidate mask tokens may include several mask tokens, for example, to evaluate the likelihood of categorically different (e.g., mutually-exclusive) types of attributes. For example, the candidate mask tokens may correspond to attributes “beef, chicken, fish, fruit, vegetable” for which food products are expected to belong to one of these types. Similarly, the candidate mask tokens 540 may not be mutually exclusive, and may each represent separate, independent attributes, such as “Dairy” “Nuts” “Gluten” etc.

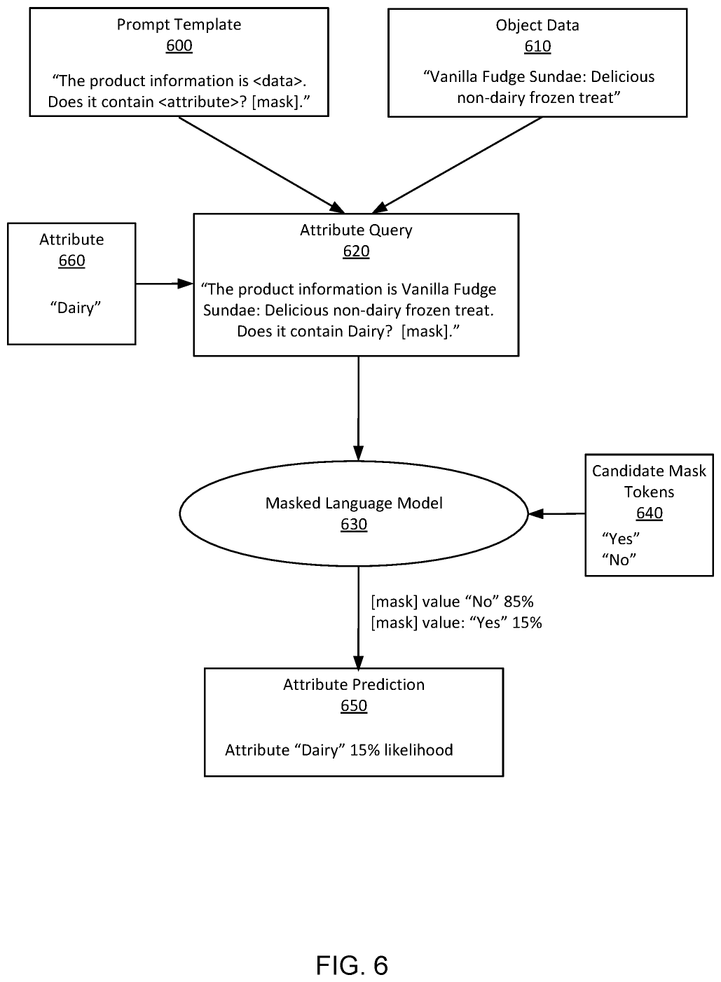

FIG. 6 shows a further flowchart for determining an attribute prediction with a masked language model, according to one or more embodiments. Similar to the example of FIG. 5, the example of FIG. 6 applies an attribute query 620 to candidate mask tokens 640 to determine the attribute prediction 650 of the product. In this example, rather than using candidate mask tokens that describe the attribute (e.g., “Dairy-free” or “non-dairy” candidate mask tokens for the product attribute of containing no dairy ingredients), the attribute 660 is represented as a label in the attribute query 620 that may be structured such that the candidate mask tokens 640 may represent Boolean positive or negative (e.g., “Yes/No” or “True/False”) responses to a question or preposition of the attribute query 620. In the example of FIG. 6, the attribute query 620 inserts the product information and then formulates the attribute as a question (“Does it contain <attribute>”) such that the masked language model 630 may respond to the question context of the attribute query 620 with the candidate mask tokens 640 positively or negatively. In this example, the prompt template 600 includes a location at which to insert the object data 610 in addition to another location at which to insert the attribute 660. This may also permit different attributes to be inserted to the prompt template for evaluation of the respective attributes. In this example, the candidate mask tokens 640 represent positive/negative responses (“Yes” and “No”) to the attribute query, which may correspond to an attribute prediction 650 for the attribute 660.

### Language Model and Template Training and Selection

The examples of FIGS. 5 and 6 show uses of a query template for leveraging the text and context represented within a masked language model that may be learned from a general language corpus. As also discussed above with respect to FIG. 3, the model may be trained (at least initially) with training data that might not include attribute queries. This permits the masked language model to learn sophisticated text tokens and contextual relationships between language elements that, with the structure of the attribute queries, may be used to extract information from the model in predicting attributes based on the learned relationships from the general language training data. In some embodiments, the masked language model may be further trained (e.g., fine-tuned) using attribute queries with known attribute predictions. For example, items having known attributes (e.g., as provided from a manufacturer, warehouse, or manually labeled) may be used to generate an attribute query 620 to be input to the masked language model with a training objective of predicting the known label. While the number of these training data instances may be relatively small relative to the training data unrelated to the attribute query, this fine tuning may permit the masked language model to adjust parameters towards the particular attributes, attribute query structure, and candidate mask tokens used in attribute prediction. As one benefit, while fine tuning of other language models may mean adding additional “heads” on a base language model (and adding additional parameters), the fine tuning of the masked language model in this way may modify existing parameters without increasing the model complexity.

In addition to fine-tuning the masked language models, the particular terms used for an attribute (e.g., either as candidate mask tokens or as an attribute in the attribute query as shown in FIGS. 5 and 6, respectively) may also be learned in various embodiments.

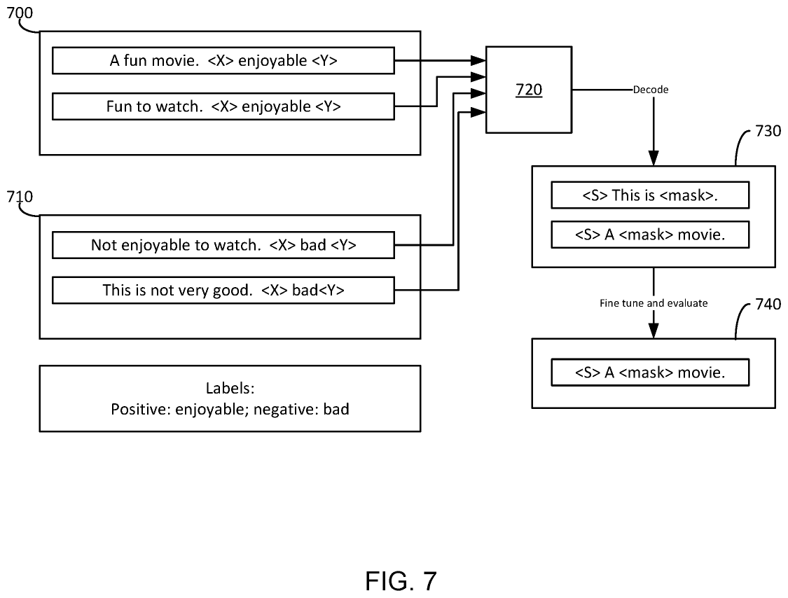

FIG. 7 shows an example flow for determining one or more prompt templates for use in attribute prediction by a masked language model, according to one or more embodiments. While in some instances the prompt template may be manually designed, FIG. 7 provides an approach for automatically generating effective prompt templates for use with the masked language model.

For determining the prompt templates, a number of known training instances may be used, such that the object data (i.e., the text string describing the object) may be known, along with the attribute label of the object, such as “dairy” or “dairy-free.” In the example of FIG. 7, the attribute is a sentiment of an object, such as “great” or “terrible.” This may be, for example, reviews of a movie. In this instance, the object data is known, as is the attribute prediction, such that an effective prompt should be generated such that the application of the prompt to the object data may effectively yield the attribute as a predicted mask token by the masked language model. More formally, the problem for generating the prompt may be characterized as identifying one or more spans of text in which the object data and the masked label may be positioned. More formally, this may be described as determining the values X and Y in: “<object data> X <attribute> Y” such that the attribute may be predicted as a mask token by the masked language model.

In one example, the template prompts are generated with a text-text machine learning model, such as a text-to-text transformer (“T5”) that may generate text outputs (including a span or sequence of text tokens) based on a text input. As shown in FIG. 7, positive training instances 700 and negative training instances 710 may be generated with respective object data (e.g., “A pleasure to watch”) and corresponding attribute labels (e.g., “great”). The text-text model 720 may receive the instances and generate templates 730 that represent probable text (e.g., one or more text tokens) for respective portions of the input training instances. For example, X may be “This is” and Y may be “.” in the example above. The generated templates 730 may then be further evaluated by assessing the performance of each generated template 730 on known training instances of the object data and labeled attributes. The best-performing generated template 730 may then be selected as the template for which to fine-tune the language model and to be used as the selected template 740 for attribute prediction.

In addition, the particular text tokens to be used for predicting a particular class or attribute may also be evaluated for selection. For a particular semantic concept, such as the attribute “contains no dairy,” several possible text tokens may represent this concept, such as “dairy-free,” “non-dairy,” “milk-free,” “lactose-free,” and so forth. However, including several such semantically similar tokens as candidate mask tokens may negatively affect the attribute prediction, such that it may be beneficial to select one mask token as a label to represent the semantic concept. To evaluate possible candidate mask tokens, the product information may be provided to the language model, such that the text tokens having a high prediction as the masked value may be considered as possible labels for the attribute. These possible labels may then be evaluated with respect to other known training data to determine whether the label effectively generalizes across additional instances. The label (e.g., the text token) that performs well when used as a candidate mask token may then be used to represent the attribute's semantic concept.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, at a computer system comprising at least one processor and memory:
identifying object data for an object including a text string;
generating an attribute query having a masked value by adding the object data to a prompt template having the masked value; and
predicting an attribute of the object based on a prediction of the masked value by applying a trained masked language model to the text string, the trained masked language model outputting a likelihood that the attribute following the text string.

2. The method of claim 1, wherein the object is a product and the text string is a product description of the product.

3. The method of claim 1, wherein predicting an attribute of the object comprises predicting, by the trained masked language model, a value for each of a set of candidate attributes.

4. The method of claim 3, wherein the attribute is one of the set of candidate attributes.

5. The method of claim 3, wherein the attribute query includes the attribute, and wherein the set of candidate attributes include a positive mask token and a negative mask token.

6. The method of claim 1, wherein the masked language model is trained with a training set including training instances that are based on information from an encyclopedia, webpages, or object information.

7. The method of claim 1, wherein the masked language model is trained with a training set including training instances that are not based on the prompt template.

8. The method of claim 7, wherein the masked language model is trained based on another training set including labeled attribute queries.

9. The method of claim 1, further comprising:
determining the prompt template based on a text-text transformer.

10. The method of claim 1, further comprising:
receiving an object query; and
selecting the object as responsive to the object query based on the predicted attribute of the object.

11. A computer program product comprising a non-transitory computer readable storage medium having instructions encoded thereon that, when executed by a processor, cause the processor to perform the steps:
identifying object data for an object including a text string;
generating an attribute query having a masked value by adding the object data to a prompt template having the masked value; and
predicting an attribute of the object based on a prediction of the masked value by applying a trained masked language model to the text string, the trained masked language model outputting a likelihood that the attribute following the text string.

12. The computer program product of claim 11, wherein the object is a product and the text string is a product description of the product.

13. The computer program product of claim 11, wherein predicting an attribute of the object comprises predicting, by the trained masked language model, a value for each of a set of candidate attributes.

14. The computer program product of claim 13, wherein the attribute is one of the set of candidate attributes.

15. The computer program product of claim 13, wherein the attribute query includes the attribute, and wherein the set of candidate attributes include a positive mask token and a negative mask token.

16. The computer program product of claim 11, wherein the masked language model is trained with a training set including training instances that are based on information from an encyclopedia, webpages, or object information.

17. The computer program product of claim 11, wherein the masked language model is trained with a training set including training instances that are not based on the prompt template.

18. The computer program product of claim 11, wherein the non-transitory computer readable storage medium further has instructions encoded thereon that, when executed by a processor, cause the processor to perform the step:
determining the prompt template based on a text-text transformer.

19. The computer program product of claim 11, wherein the non-transitory computer readable storage medium further has instructions encoded thereon that, when executed by a processor, cause the processor to perform the step:
receiving an object query; and
selecting the object as responsive to the object query based on the predicted attribute of the object.

20. A system comprising:
a processor; and
a non-transitory computer readable storage medium having instructions encoded thereon that, when executed by a processor, cause the processor to perform the steps:
identifying object data for an object including a text string;
generating an attribute query having a masked value by adding the object data to a prompt template having the masked value; and
predicting an attribute of the object based on a prediction of the masked value by applying a trained masked language model to the text string, the trained masked language model outputting a likelihood that the attribute following the text string.
